(19) United States
(12) Patent Application Publication
(10) Pub. No.: US 2015/0334979 A1
(43) Pub. Date: Nov. 26, 2015

(54) HANDHELD BRUSHLESS TEAT CLEANING APPARATUS

(71) Applicant: B&T Manufacturing LLC, Mondovi, WI (US)

(72) Inventor: Bruce A. Roytek, Mondovi, WI (US)

(21) Appl. No.: 14/719,001

(22) Filed: May 21, 2015

Related U.S. Application Data
(60) Provisional application No. 62/001,199, filed on May 21, 2014.

(51) Int. Cl. A01J 7/04; A01K 29/00; A01K 13/00

(52) U.S. Cl. CPC A01J 7/04; A01K 13/001; A01K 29/00

(57) ABSTRACT

A handheld apparatus for the cleaning of teats, which is generally done immediately prior to milking a dairy animal, such as a cow. The apparatus cleans the teats with a wash cycle that alternatingly applies a washing liquid and air to the teat surface, and optionally a disinfectant compound. After washing, the apparatus also dries and pre-milks the teat by the application of vacuum. The apparatus is lightweight (the portion held by the operator is preferably less than about 5 pounds), and includes an “on” button or switch that can only be used to initiate the washing process. The washing process can be controlled by a programmable logic controller (PLC).

### CROSS-REFERENCE TO RELATED APPLICATION

This application claims the benefit of U.S. provisional patent application Ser. No. 62/001,199, filed May 21, 2014 and incorporated herein by reference for all purposes.

### BACKGROUND

The present disclosure is directed to a device for cleaning (washing) the teats of dairy animals prior to milking. More particularly, the device is a handheld, brushless teat cleaning apparatus.

Before milking dairy animals, specifically dairy cows, it is common practice to perform a teat washing operation to remove any dirt, mud, hay or other bedding, sweat, and other material that could potentially contaminate the milk obtained from that teat. Various cleaning or washing devices have been designed to facilitate the teat washing prior to milking. Of course, the most basic method to clean the teats is manually with a towel or rag. However, as technology advances, various motorized devices have become available.

One group of devices utilizes a handheld body with rotary brushes therein. The body is provided with a bore through which a teat of the animal can be introduced into the body and which is formed in such a position that the introduced teat is brought to contact with the bristles of the rotary brushes and brushed clean. These rotary brush devices typically include a set of orifices arranged to direct washing liquid to help the action of the brushes. See, for example, U.S. Pat. Nos. 5,235,937 and 8,402,920 and U.S. Publication 2007/0175405. Typically, an operator or dairy worker manually holds these rotary brush devices during the washing process, moving the device from one teat to the other, and then from one cow to the other.

Another group of cleaning or washing devices utilizes a teat cup that is designed for both milking the animal and washing the teat immediately prior to milking. One design uses spray nozzles disposed on the upper end of the teat cup, oriented to spray the teat with washing liquid (e.g., water) prior to engaging the cup onto the teat for milking. See, for example, U.S. Pat. No. 6,234,110. Another design utilizes a cup having a flexible interior wall that pulsates and massages the teat as washing liquid is sprayed onto the teat. See, for example, U.S. Pat. No. 4,924,809. Yet another design has a cup that has an upper portion that includes the washing liquid spray mechanism for cleaning the teat and a lower portion that is movable into the upper portion for the milking process. See, for example, EP 0 801 893. In general, these teat cups with integral washing configurations are used in automatic or robotic milking operations, where no or minimal operator interaction is required.

There is a desire to have the teat washing operation be as thorough as possible, to remove as much contamination as possible prior to milking, yet be quick and easy for the operator to accomplish and to be gentle on the cow. The present invention provides a new handheld device that can readily be used in any milking operation.

### SUMMARY

This disclosure describes a handheld apparatus for the cleaning of teats, which is generally done immediately prior to milking a dairy animal, such as a cow. The apparatus cleans the teats by alternatingly applying a washing liquid and air to the teat surface and then utilizes a vacuum to remove the washing liquid; the vacuum also facilitates pre-milking or striping of the teat. The apparatus is lightweight (the portion held by the operator is preferably less than about 5 pounds, in some embodiments less than about 4 pounds), and includes an operator-gripping surface, such as a handle, and an “on” button or switch.

A first particular embodiment of this disclosure is a handheld teat washing apparatus that has a teat receiving cup having an interior surface with a plurality of apertures in the interior surface, a washing liquid source and an air source, each in fluid communication with the apertures in the interior surface of the teat receiving cup through a pulsation unit, and a programmable logic controller (PLC) operably connected to the pulsation unit, the PLC configured to provide a fluid flow of alternating washing liquid and air to the plurality of apertures. The teat receiving is free of any teat-contacting bristles. In some embodiments, the apparatus has a weight of no more than about 5 pounds, in other embodiment no more than 4 pounds.

The pulsation unit of such a handheld teat washing apparatus can have a first high speed valve to control fluid flow from the washing liquid source, and a second high speed valve to control fluid flow from the air source; these valves could be solenoid valves or other high speed valves.

The washing apparatus can include a manually activated or manually engaged activation switch. Such as switch may allow only activation and not deactivation of the fluid flow (e.g., all or some of the washing liquid, air, etc.) and vacuum. In such embodiments, the application of the fluid and vacuum to the teat is programmed in to the system and cannot be readily adjusted by the operator.

A second particular embodiment of this disclosure is a handheld teat washing apparatus configured to remove contaminant from a milking animal's teat, the apparatus providing a washing process that includes a wash cycle and a drying cycle. The wash cycle provides alternating pulses of washing liquid and air to the teat for a predetermined duration. The drying cycle applies vacuum to the teat, again, for a predetermined duration. The handheld washing apparatus is free of any teat-contacting bristles and, in some embodiments, has a weight of no more than 5 pounds or no more than 4 pounds. The apparatus may include an activation switch that can only initiate the wash cycle and cannot terminate or adjust the cycle. The apparatus may also include a programmable logic controller (PLC) configured to provide the alternating pulses of washing liquid and air during the wash cycle.

Yet another particular embodiment of this disclosure is a method of cleaning a teat prior to milking. This method includes having an operator place a brushless teat washing apparatus into contact with the teat, the teat being positioned within a teat-cleaning cup of the washing apparatus, the operator holding the teat-cleaning cup with the teat at least partially within the cup, and then the operator initiating a washing process, thereby providing alternating pulses of washing liquid and air to the teat, and providing vacuum to the teat.

In such a method, the washing process can have a duration of no greater than 30 seconds, in some embodiments no greater than 20 seconds, and in other embodiments no greater than 15 seconds. The washing process includes a wash cycle that provides the alternating pulses of washing liquid and air to the teat, and a drying cycle that provides vacuum to the teat. A rinse cycle may be present between the wash cycle and the drying cycle.

A wash cycle, in some embodiments, has a duration of no greater than 15 seconds, in some embodiments no greater than 10 seconds. The pulses of washing liquid and vacuum, either or both pulse duration and pulse frequency, may be the same or may be different. For example, each pulse of washing liquid may have a duration of less than one second, for example, 0.5 second or 0.25 second, and the pulse of air can likewise have a duration of less than one second, for example, 0.5 second or 0.25 second. The drying cycle, in some embodiments, has a duration no greater than 10 seconds, in some embodiments no greater than 5 seconds, and in some embodiments 2 seconds.

In the method, the operator can initiate the washing process by engaging an activation switch configured to only initiate the washing process; in such embodiments, the operator cannot alter the steps or duration of the washing process, or cancel or abort the washing process. Any change to the washing process would have to be made at the system level, e.g., at the controller.

In yet another particular embodiment of this disclosure, an apparatus is provided that is configured to wash, dry and strip the pre-milk from an animal without intended contact by a solid mechanism, such as bristles.

These and various other features and advantages will be apparent from a reading of the following detailed description.

### BRIEF DESCRIPTION OF THE DRAWING

The disclosure may be more completely understood in consideration of the following detailed description of various embodiments of the disclosure in connection with the accompanying drawing, in which:

FIG. 1 is a perspective view of a portion of a dairy animal, in this figure a cow, with a cleaning apparatus according to the present disclosure positioned in preparation for positioning on a teat of the animal.

FIG. 2 is a schematic block diagram of a cleaning system according to the present disclosure.

FIG. 3 is a perspective side view of an embodiment of the cleaning apparatus of the present disclosure positioned on the teat of an animal prior to milking.

FIG. 4 is a schematic diagram of another cleaning system according to the present disclosure.

FIG. 5 is an exploded perspective view of a teat cup portion of a cleaning apparatus of the present disclosure.

### DETAILED DESCRIPTION

The present disclosure provides a handheld, brushless teat cleaning apparatus for cleaning (washing) the teats of dairy animals prior to milking and a system that includes such a brushless teat cleaning apparatus. The apparatus includes a teat-receiving cup having a plurality of fluid-injecting apertures therein. During a wash cycle, alternating pulses of washing liquid and air are applied through the apertures to the teat to remove dirt, mud, bedding and other contaminants from the teat surface. The apparatus can be referred to as ‘touchless’, as no cleaning is done by physical contact from a brush, bristle, towel, or other such item, but rather, only fluid (e.g., washing liquid and air) are used to clean the teat. An optional rinse cycle, which utilizes water, may follow the wash cycle. After the wash cycle and optional rinse cycle, a vacuum dries and pre-milks (strips) the teat. Accordingly, the term “wash cycle” refers to the time period during which air and washing liquid are applied to the teat, whereas the term “washing process” and variations thereof includes the wash cycle and also any rinse cycle, the drying cycle and pre-milking processes, unless otherwise specified. A “washing apparatus”, “cleaning apparatus” and variations thereof, is a device used for the washing process and a fluid supply source that includes the controller that provides air, washing liquid and vacuum to the device. A “system” and variations thereof includes the apparatus (i.e., the device and controller with appropriate programming to provide pulsatile flow of fluid), and also a liquid source and a vacuum source.

It is to be understood that although the following discussion is directed to a teat washing apparatus for dairy cows, the apparatus could be used on other milk producing animals such as goats, sheep, camels, buffalo, llamas, etc.

In dairy farms where preliminary teat washing procedures are manually done before milking, a dairy worker or operator is responsible for washing a large number of animals. Depending on the equipment and its arrangement, the operator may be working in confined spaces and/or in inconvenient positions. It is therefore a desire that the teat washing operation is quickly performed in an efficient and flexible manner. The teat washing apparatus of the present disclosure is a lightweight, easy to handle and manipulate, teat washing apparatus that thoroughly washes, pre-milks and dries the teat while minimizing operator variability, both among operators and for an individual. Because the washing process is automated, the cleanliness is consistent from animal to animal.

In the following description, reference is made to the accompanying drawing that forms a part hereof and in which are shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the invention will be gained through a discussion of the example provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

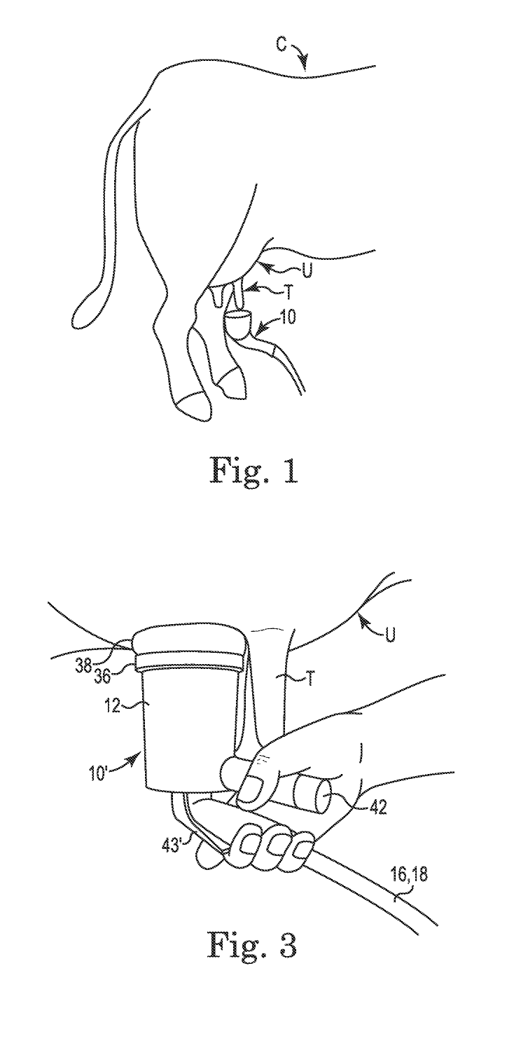

FIG. 1 illustrates a diary cow C being prepared for milking. Teat cleansing apparatus 10 is positioned directly under the udder U of the cow C, aligned with a teat T. To prepare teat T for milking, an operator (not shown) will raise up, place and hold apparatus 10 on teat T (e.g., in some embodiments forming a seal on teat T) and apparatus 10 will wash the teat and pre-milk or strip the teat. After washing and pre-milking, the teat surface is dried by apparatus 10. The cow is now ready for milking.

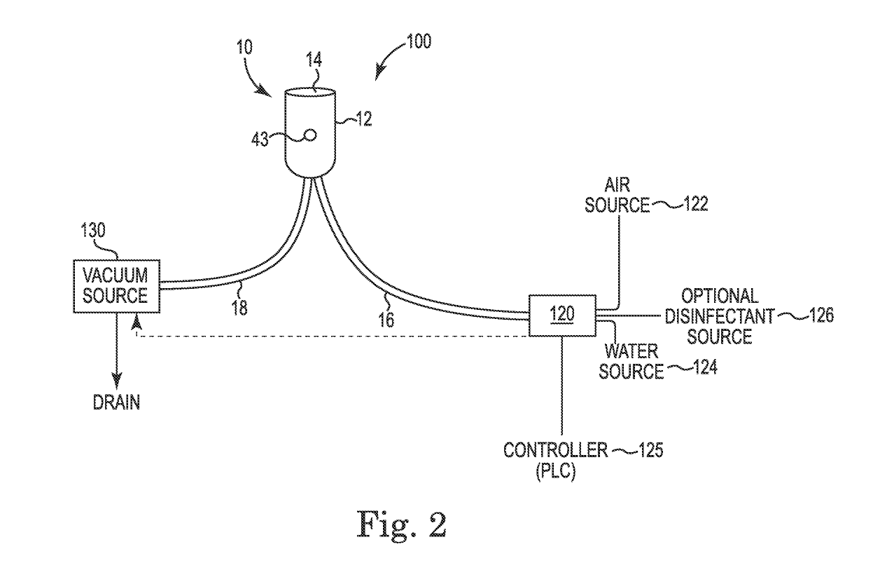

FIG. 2 provides a schematic diagram of a system 100 that includes apparatus 10 connected to a fluid supply source 120 and a vacuum source 130. Apparatus 10 includes a substantially cylindrical teat-cleaning cup 12 with a teat receiving opening 14 at its upper end leading to an interior volume (not seen) of cup 12. Cup 12 is operably connected via a first or supply line 16 to fluid supply source 120 that provides at least two fluids for washing of the teat, and cup 12 is also operably connected via a second or drain line 18 to vacuum source 130 and a subsequent drain. First line 16 provides a supply of air from an air source 122 and a supply of washing liquid from a water or other washing liquid source 124 to teat-cleaning cup 12. Together, the washing liquid and air wash the teat and remove essentially all dirt, mud, hay, and other contamination therefrom. As will be described further below, apparatus 10 has a wash cycle that supplies the washing liquid and the air in an alternating manner.

As indicated, gas, generally air, is provided by source 122, which may be, for example, a pressurized tank or canister, a compressor, or may even be ambient air. Washing liquid is provided by a water source 124, which may be, for example, a fixed volume of liquid such as a tank or bucket, or may be a continuous source, such as a faucet. In some embodiments, it may be desirable to have warmed washing liquid, to facilitate softening and removal of dirt and mud from the teat and also provide a more comfortable experience for the cow.

The air and washing liquid are fed into supply line 16 at fluid supply source 120, which provides the fluids in alternating pulses. The air and washing liquid are not mixed prior to or in fluid supply source 120, but are fed in an alternating manner to supply line 16 by source 120. Fluid supply source 120 includes a high speed valve, such as a solenoid valve, or a valve whose operation is actuated by a magnetic actuator or a voice coil for each fluid source (e.g., air source 122 and water source 124). During the wash cycle, fluid supply source 120 sequentially supplies one fluid (e.g., air) into supply line 16 and then the other fluid (e.g., washing liquid). Theses pulses of fluid are provided individually to supply line 16, providing alternating discrete pulses or ‘plugs’ of each fluid. It is noted that although some mixing of air and washing liquid may occur, the two fluids remain predominantly separate.

An antibacterial or disinfectant compound, such as iodine or a chlorite compound (e.g., chlorhexidine), may be included in the wash cycle. The compound may be applied to the teat surface during the entire wash cycle or for only the last few cycles of the wash cycle. A preferred antibacterial or disinfectant compound is an iodine solution at a level of 25-50 ppm in water; another preferred antibacterial or disinfectant compound is lactic acid, provided at 2% and diluted 1:9 with water to form a 0.2% solution. The antibacterial or disinfectant compound may be provided by source 126 to fluid supply source 120 where it is mixed with water from source 124 or the compound may be mixed with water from source 124 and the resulting solution provided to fluid supply source 120.

During the wash cycle, fluid supply source 120 provides air and washing liquid (and optional antibacterial or disinfectant compound) to supply line 16 and subsequently to teat-cleaning cup 12 as discrete pulses in an alternating manner. The air and washing liquid can be generally described as being in plug flow, although some mixing of the fluids may occur at their interface.

A controller 125, such as a PLC (programmable logic controller), controls the high speed valves of fluid supply source 120 and thus the flow of air from source 122, washing liquid from source 124 and optionally disinfectant from source 126. Controller 125 can be configured to produce a wash cycle of, for example, 10 seconds, 20 seconds, or 30 seconds; additionally, shorter and longer wash cycles could be used. The “wash cycle” is that period of time when the air, washing liquid and any disinfectant are provided to teat-cleaning cup 12. Typically, a wash cycle of no more than 30 seconds is needed to thoroughly wash the teat. If, by chance, the teat still has contaminant thereon after a wash cycle, a second cycle may be applied. Controller 125 also controls the duration and frequency of the washing liquid and air pulses.

During the wash cycle, air from source 122 and washing liquid from source 124 are alternately provided to supply line 16 from fluid supply source 120. Each application, pulse or plug of each fluid (i.e., of air, of washing liquid, and optionally of disinfectant) has a duration of less than 1 second, for example, 0.5 second, 0.2 second, or 0.1 second. The duration of air may be the same as that of the washing liquid, or the durations may differ. The air and washing liquids may immediately follow one another or there may be a ‘downtime’ between pulses. The number of pulses or cycles of air and washing liquid may be, for example, 10 cycles, 20 cycles, etc. The first pulse in a wash cycle may be either the air or washing liquid; likewise, the last pulse in a wash cycle may be either the air or washing liquid. One particular wash cycle has a total duration of 5 seconds, with alternating pulses of air and water/disinfecting solution, each pulse being 0.25 seconds.

As indicated above and shown in FIG. 2, apparatus 10 also includes second or drain line 18 operably connected to teat-cleaning cup 12, typically at the bottom end of cup 12. Drain line 18 provides an exit for fluid from the interior volume of teat-cleaning cup 12. A vacuum source 130 is connected to drain line 18 to supply a vacuum or other under-pressure to the interior volume of teat-cleaning cup 12 to facilitate draining used wash cycle fluid from teat-cleaning cup 12 after the wash cycle. Vacuum sources are common in milking facilities, as most milking operations rely on vacuum to extract the milk from the cow and to transport the extracted milk. Teat-cleaning cup 12 may be under vacuum or under-pressure during the wash cycle, to quickly and thoroughly remove dirtied washing liquid from cup 12. After the wash cycle, the vacuum or under-pressure is instrumental in pre-milking and drying the teat. The application of the vacuum or under-pressure to cup 12 is also controlled by controller 125. The vacuum may be provided to teat-cleaning cup 12 as pulses or continually; the vacuum level may be constant or may be ramped, stepped, or otherwise non-constant. The vacuum not only removes trace amounts of liquid from the teat, thus drying the surface of the teat, but also stimulates the teat, facilitating milk let-down and stripping of the pre-milk. One particular wash cycle provides continuous vacuum for 2 seconds after the air and washing liquid.

A waste tank may be situated to collect used wash cycle fluid and the pre-milk or the waste fluid may pass directly to a sewage system or a suitable other drain. In some embodiments, a milk detector may be present for detecting any presence of milk in the waste fluid but also for possible examination of extracted pre-milk.

Returning to controller 125, a programmable logic controller (PLC) is the preferred controller 125, because a PLC can easily be reprogrammed or adjusted to modify, for example, any or all of the wash cycle duration, the duration of each fluid, the duration of vacuum, etc., depending on the desired process. Controller or PLC 125 is configured to provide control signals to the high speed valves of fluid supply source 120 to control the flow of air, washing liquid and disinfectant to teat-cleaning cup 12. Additionally, controller or PLC 125 controls vacuum source 130. Controller or PLC 125 receives power from either a DC or AC power supply.

Apparatus 10 includes an “on” button, toggle or switch 43, seen in FIG. 2, used to initiate the washing process. Switch 43 is configured as an ‘on-only’ switch, initiating the washing process when activated or engaged by the operator. The washing process, including the wash cycle and drying, is completely controlled by controller 125, thus eliminating any action needed by the operator other than to hold apparatus 10 in position and initiate the washing process via switch 43. For example, the operator cannot terminate the washing process once initiated nor can the operator adjust the wash cycle duration nor any other part of the washing process; because of this, each cow is cleansed in the same manner, resulting in a consistent washing process for the entire herd. To adjust any of the washing process parameters, the controller or PLC 125 can be reprogrammed.

FIG. 3 shows an embodiment of an apparatus 10′ cleaning (washing) and pre-milking teats T of a cow's udder U. In this figure, apparatus 10′ includes teat-cleaning cup 12 connected to a washing liquid source via hose 16 and to a vacuum source via hose 18. Cup 12 includes an interior volume (not seen) and an opening (not seen in FIG. 3, but seen in FIG. 2 as opening 14) for receiving teat T into the interior volume. Cup 12 further includes a ring-shaped collar 36 onto which seats a conformable and/or compressible member 38. A handle 42 provides a structure for positioning and holding of apparatus 10′ by the operator on teat T, and a switch 43′ is included for initiating the washing process. It is understood that the washing apparatus of this disclosure may have any type of suitable handle or operator gripping surface, as long as the overall configuration of the washing apparatus remains readily handleable by the operator. The apparatus 10′, particularly the portion manipulated and/or held by the operator during use, does not weigh more than about 5 lbs, in some embodiment not more than about 4 lbs, thus decreasing operator fatigue and potential injuries due to repetitive motion.

The process of using apparatus 10 or apparatus 10′ follows generally the following procedure. Teat-cleaning cup 12 is placed under udder U of an animal (e.g., cow C of FIG. 1) with opening 14 (FIG. 2) below a teat T which is to be cleaned; see FIG. 1 for placement of apparatus 10, 10′ in respect to cow C, udder U and teat T. Apparatus 10, 10′ is positioned under and on teat T manually by the dairy worker or operator. After properly positioning apparatus 10, 10′ in relation to teat T, teat-cleaning cup 12 is raised by the operator so that the teat enters teat-cleaning cup 12 through opening 14 and is received in the interior volume of cup 12. In some embodiments, member 38 around opening 14 seats against and provides a cushion between cup 12 and udder U.

After placing teat-cleaning cup 12 on the teat T, the operator activates switch 43′, so that controller 125 (e.g., PLC 125) alternatingly activates the valves of fluid supply source 120 to provide alternating pulses of air from source 122 and washing liquid from source 124 for the programmed wash cycle duration to the teat T. The alternating pulses may or may not be equally distributed circumferentially around teat-cleaning cup 12 at a point in time, and may or may not be equally distributed from the top to bottom of teat-cleaning cup 12 at a point in time. As described above, disinfectant may be present in the washing liquid from source 124 or, disinfectant from source 126 may be used, for example, during the last portion of the wash cycle.

In some embodiments, vacuum source 128 is activated and vacuum is applied to teat-cleaning cup 12 via drain line 18 near the end of the wash cycle. Facilitated by the vacuum, the washing liquid is evacuated from cup 12 via drain line 18 and disposed.

After the predetermined wash cycle, apparatus 10 performs a drying cycle with the vacuum (for approximately 2 to 10 seconds), thus drying the teat by evacuating any remaining liquid from cup 12 and from the surface of the teat. Additionally, the vacuum of the drying cycle stimulates the teat, facilitating milk let-down and pre-milking or striping the teat of the pre-milk.

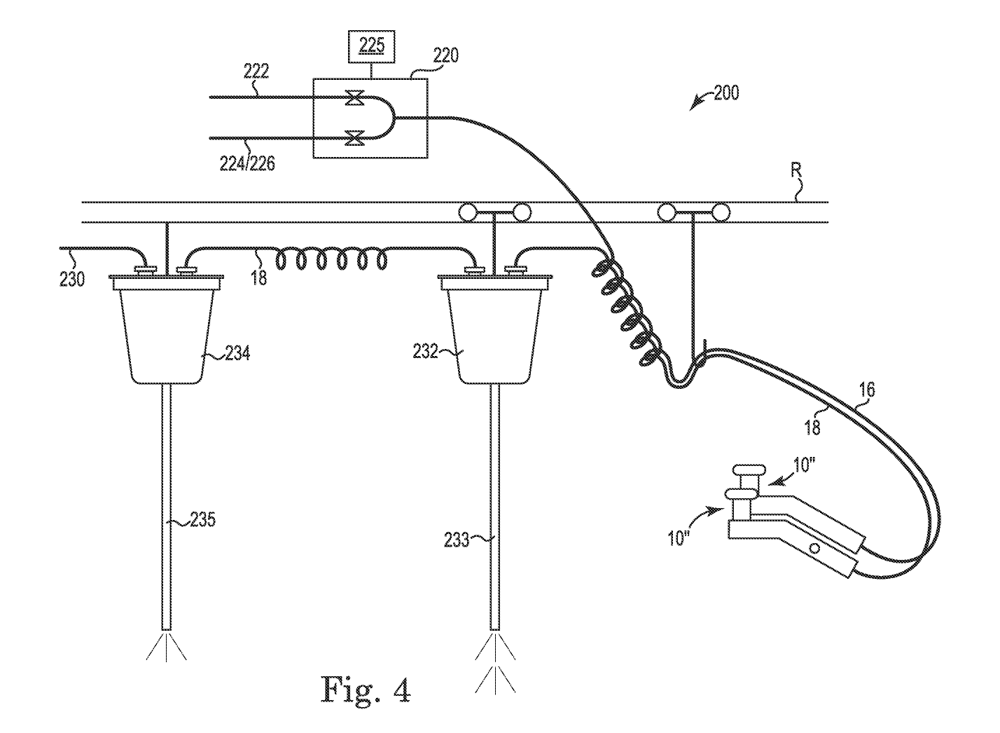

FIG. 4 shows an embodiment of a system 200 that includes two washing apparatuses; this allows two teats to be washed simultaneously. System 200 includes two washing apparatus 10″ (similar to apparatus 10′ of FIG. 2) connected to a fluid supply source 220 and a vacuum source 230. Fluid supply source 220 is fed by air source 222 and a combined washing liquid and disinfectant source 224/226. Fluid supply source 220 includes a valve (for example, a high speed solenoid valve) for each of the air and the washing liquid and disinfectant. Fluid supply source 220, particularly the valves that are part of source 220, are controlled by a PLC or controller 225. PLC 225 controls the valves so that alternating pulses or plugs of air and liquid are provided to apparatus 10″ via supply line 16. Vacuum source 230, in this embodiment, is the vacuum commonly present in a milking parlor; vacuum is provided to apparatus 10″ via supply line 18.

System 200 is configured for a milking parlor having a central aisle with a rail R extending down the central aisle. As indicated above, vacuum source 230 is the vacuum used for the milking process. To inhibit used washing liquid, pre-milk and contaminants from entering the vacuum system, system 200 includes two pots 232, 234 in-line between apparatus 10″ and vacuum source 230. Primary pot 232, having drain 233, is positioned closer to apparatus 10″ than secondary pot 234, which is a back-up to primary pot 232 that has a drain 235. Either or both pots 232, 234 can have a backflow preventer to further inhibit used washing liquid, pre-milk and contaminants from entering the vacuum system.

System 200 is configured with sufficiently long supply lines 16, 18 to allow the operator to move the apparatus 10″ down the central aisle of a milking parlor. Additionally, at least some of the equipment of system 200 (in this configuration, primary pot 232) is moveably supported on the rail R extending down the central aisle. Such a set-up allows the operator to readily move (pull) the system from cow to cow.

Similar to the system in FIG. 2, the air and washing liquid are fed into supply line 16 at fluid supply source 220, which provides the fluids in alternating pulses. Together, the washing liquid and air wash the teat and remove dirt, mud, hay, and other contamination from the teat being washed, and the vacuum dries and strips the pre-milk.

At least one apparatus 10″ includes an “on” button, toggle or switch (e.g., switch 43 seen in FIG. 2), used to initiate the washing process. The switch is configured as an ‘on-only’ switch, initiating the washing process when activated or engaged by the operator. In this embodiment, one switch controls both apparatus 10″. As in the system of FIG. 2, the washing process, including the wash cycle and drying, is completely controlled by controller 225, thus eliminating any action needed by the operator other than to hold apparatus 10″ in position and initiate the washing process via the switch.

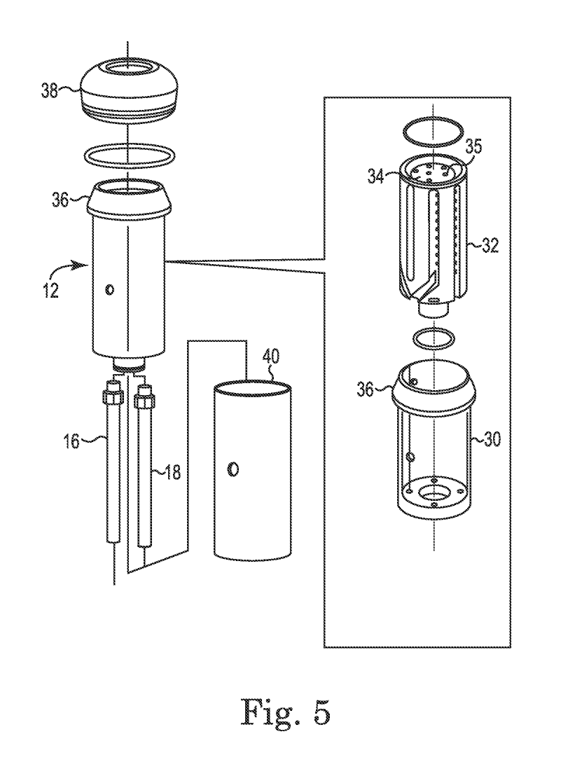

Various details of teat-cleaning cup 12, of any or all of apparatus 10, 10′ and 10″, are shown in FIG. 5.

Teat-cleaning cup 12 includes a double-walled cylindrical or essentially cylindrical cup of a non-collapsible material (e.g., stainless steel) having an outer portion 30 and an inner liner 32 defining an internal volume 34 accessible via opening 14 (FIG. 2). Inner liner 32 is provided with a plurality of apertures 35 therethrough, apertures 35 being in fluid communication with supply line 16. At the bottom of cup 12 (through both outer portion 30 and inner liner 32) is a drain in fluid communication with drain line 18. A sleeve 40 covers and protects outer portion 30.

Supply line 16 is in fluid communication with apertures 35 by way of an annular space between outer portion 30 and inner liner 32. This annular space may be divided into channels to improve even distribution of the washing liquid and air from supply line 16 among all apertures 35. If present, the channels can be located side by side along the periphery of the annular space.

Apertures 35 may be round, oval or elongated, linear slots, or have another suitable configuration and are distributed around the circumference of inner liner 32. Washing liquid and air are supplied from supply line 16 to the annular space of cup 12 and are forced through apertures 35 as fluid jets towards a teat inserted into interior volume 34 through opening 14. Apertures 35 may be oriented such that the jets of washing liquid and the flow of air point radially to the center or are slightly tangentially directed to achieve a rotational movement of fluid in internal volume 34 of cup 12. Similarly, apertures 35 may be oriented such that the jets are horizontal (or orthogonal to inner liner 32) or oriented obliquely upwards or downwards. A diverter may be present to evenly distribute the incoming washing liquid and air around cup 12 or to adjust the pressure and/or flow of the fluids through apertures 35.

At its open end, outer portion 30 includes ring-shaped collar 36 onto which seats conformable and/or compressible sealing member 38. Cleaning cup 12 includes various seals, gaskets and other elements.

It is understood that numerous variations could be made while maintaining the overall inventive design of the washing apparatus and of the system. Numerous alternate design or element features have been mentioned above. Other alternate designs include, for example, different handle or gripping surface configurations, different activation switches, different cup configurations, including different aperture configurations, etc. As another alternate embodiment of a washing device of this disclosure, fluid supply source 120 or other manifold-type device could be eliminated, by having each of air source 122 and washing liquid source 124 directly controlled by controller 125, with each source 122, 124 providing its fluid directly to teat-cleaning cup 12.

The teat washing apparatus can be used in any type of milking configuration or equipment that utilizes operators to manually do the washing procedure. The teat washing procedure with the inventive apparatus could be done with the cow already in position to be milked, for example, in stanchions or in any parlor configuration (e.g., herringbone, side-by-side). The operator may need to move from one cow to the next, or remain stationary while the cow progresses to him, such as in a rotary or carousel milking operation. The teat washing procedure with the inventive apparatus could alternately be done in a location physically separated from the milking system, as in a teat preparation area (see U.S. Publication 2010/0282172 for one example of a teat preparation area physically separate from the milking system).

Thus, embodiments of the HANDHELD BRUSHLESS TEAT CLEANING APPARATUS are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A handheld teat washing system comprising:
an apparatus having a teat receiving cup having an interior surface with a plurality of apertures;
a fluid supply source in fluid communication with the apertures in the interior surface of the teat receiving cup; and
a programmable logic controller (PLC) operably connected to the fluid supply source, the PLC configured to provide a fluid flow of alternating washing liquid and air to the plurality of apertures;
the apparatus having a weight of no more than about 5 pounds, and being free of any teat-contacting bristles.

2. The handheld teat washing system of claim 1 wherein the fluid supply source has a first high speed valve to control fluid flow from a washing liquid source, and a second high speed valve to control fluid flow from an air source.

3. The handheld teat washing system of claim 2 wherein the first and second high speed valves are solenoid valves.

4. The handheld teat washing system of claim 1 further comprising an activation switch.

5. The handheld teat washing system of claim 4 wherein the activation switch is only an activation switch and not a deactivation switch.

6. A handheld teat washing system configured to remove contaminant from a milking animal's teat, the system having a handheld teat washing apparatus configured with a washing process that includes:
a wash cycle that provides alternating pulses of washing liquid and air to the teat, the wash cycle having a predetermined duration; and
a drying cycle that applies a vacuum to the teat;
the handheld teat washing apparatus having a weight of no more than about 5 pounds and being free of any teat-contacting bristles.

7. The handheld teat washing system of claim 6 further comprising an activation switch configured to only initiate the washing process.

8. The handheld teat washing system of claim 6 further comprising a programmable logic controller (PLC) configured to provide the alternating pulses of washing liquid and air.

9. The handheld teat washing system of claim 6 wherein the washing process has a duration of no greater than 30 seconds.

10. The handheld teat washing system of claim 6 wherein the pulse of washing liquid is one second or less.

11. The handheld teat washing system of claim 6 wherein the pulse of air is one second or less.

12. The handheld teat washing system of claim 6 wherein the pulse of washing liquid and the pulse of air are each 0.5 seconds or less.

13. The handheld teat washing system of claim 6 wherein the wash cycle provides a disinfectant compound to the teat.

14. The handheld teat washing system of claim 6 wherein the drying cycle has a duration of no greater than 10 seconds.

15. A method of cleaning a teat prior to milking, the method comprising:
having an operator place a brushless teat washing apparatus into contact with the teat, the teat being positioned within a teat-cleaning cup of the washing apparatus; and
the operator initiating a washing process, thereby providing alternating pulses of washing liquid and air to the teat, and providing vacuum to the teat, the operator holding the teat-cleaning cup in contact with the teat.

16. The method of claim 15 wherein the washing process has a duration of no greater than 30 seconds.

17. The method of claim 16 wherein the washing process includes a wash cycle that has a duration of no greater than 20 seconds.

18. The method of claim 16 wherein the pulse of washing liquid is less than one second.

19. The method of claim 18 wherein the pulse of air is less than one second.

20. The method of claim 15 further comprising applying a disinfectant compound to the teat during the washing process.

21. The method of claim 15 wherein the step of the operator initiating a washing process comprises the operator engaging an activation switch configured to only initiate the washing process.
